(19) United States
(12) Patent Application Publication
(10) Pub. No.: US 2004/0079629 A1
(43) Pub. Date: Apr. 29, 2004

(54) Distillation and recycling treatment device

(76) Inventor: Jim Wu, Taipei (TW)

Correspondence Address: Jim WU, PO Box 82-144, TAIPEI, TW

(21) Appl. No.: 10/282,050

(22) Filed: Oct. 29, 2002

(51) Int. Cl. B01D 3/42; B01D 3/00

(52) U.S. Cl. 202/197; 202/160; 159/901; 203/40; 203/98; 203/2

(57) ABSTRACT

A distillation and recycling treatment device is disclosed. The device is characterized in that the bottom end of the vapor tank is provided with a heater, and the top end of the vapor tank is provided with a baffling tank covered with a baffle, the external end of the baffling tank is extended to a baffling tube connected to a cooling buffer region having a condensation region and a buffering region, the condensation region connects the cooling inlet or outlet for feedback cooling and the upper end of the buffering region via the condensation region is provided with a hollow sleeve connected to the baffling tube, and the lower end of the buffering region is provided with an outlet connected to the baffling tube, whereby liquid for distillation is heated to vapor which flows into the condensation region as condensate via the baffle and the baffling tank and via the baffling tube, to the cooling buffering region so as to complete distillation and recycling, by means of the partitioning of the baffling tank to form the condensation region the recycled liquid will not re-flow but smoothly flow to the baffling tube.

### BACKGROUND OF THE INVENTION

(a) Technical Field of the Invention

The present invention relates to a distillation and recycling treatment device, and in particular, a device employing constant temperature and reduced pressure design to perform distillation and recycle treatment.

(b) Description of the Prior Art

Waste solvents are found in fabrication processes in the fields of mechanical, electronic, chemical, pharmaceutical, and food processes. If these waste solvents are discharged without going through a re-cycle process, the solvents will pollute the environment. However, if these solvents are recycled for used in other processes, environment pollution will be mitigated and the cost of production will be reduced.

A common method of recycling waste solvent is by a distillation and recycling device having a simple distillation tank with a baffling tube connected at the top section thereof. A heater is mounted to the external of the distillation tank. If waste solvents for recycle is placed to the tank, heating by the heater the solvents until vapor enters the baffling tube to obtain recycled solution. However, the change of state from liquid or solid state to vapor state, if the temperature of the reduced pressure have not been regulated, the flow rate of the recycled solvent is low and the recycled solvent will flow back into the distillation tank. As a result, it is a waste of time in treating the waste solvent and the recycled solvent is low. Therefore it is an object of the present invention to provide a distillation and recycling treatment device which solves the above drawbacks.

### SUMMARY OF THE INVENTION

Accordingly, it is an object of the present invention to provide a distillation and recycling treatment device which improves the efficiency of recycling process, and lowers the cost of production.

An aspect of the present invention is to provide a distillation and recycling treatment device having a vapor tank, characterized in that the bottom end of the vapor tank is provided with a heater, and the top end of the vapor tank is provided with a baffling tank covered with a baffle, the external end of the baffling tank is extended to a baffling tube connected to a cooling buffer region having a condensation region and a buffering region, the condensation region connects the cooling inlet or outlet for feedback cooling and the upper end of the buffering region via the condensation region is provided with a hollow sleeve connected to the baffling tube, and the lower end of the buffering region is provided with an outlet connected to the baffling tube, whereby liquid for distillation is heated to vapor which flows into the condensation region as condensate via the baffle and the baffling tank and via the baffling tube, to the cooling buffering region so as to complete distillation and recycling, by means of the partitioning of the baffling tank to form the condensation region the recycled liquid will not re-flow but smoothly flow to the baffling tube. By means of the constant temperature of the pressure within the distillation tank and the reduced pressure column, the present distillation and recycling device improves recycling process and lowers the cost of production.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a partial sectional view of the distillation tank of a preferred embodiment in accordance with the present invention.

FIGS. 2A and 2B show schematically the baffle of the preferred embodiment in accordance with the present invention.

FIGS. 2C and 2D show schematically the baffling tank of the preferred embodiment in accordance with the present invention.

FIG. 3 is a top view of the preferred embodiment in accordance with the present invention.

FIG. 4 is a sectional view of the preferred embodiment in accordance with the present invention.

FIG. 5 is a partial enlarged view of the cooling buffer region of the preferred embodiment in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

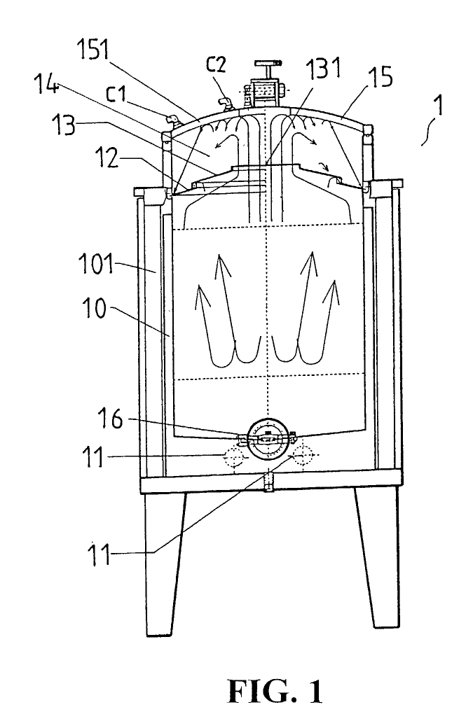

Referring to FIG. 1, there is shown a sectional view of the recycling and distillation device of the present invention comprising a vapor tank 1 of appropriate cavity. The external layer of the tank 1 is covered with a heating layer 10 and a temperature maintaining layer 101. The bottom end of the heating layer 10 is disposed with a heater 11 which heats a heating medium to provide heat indirectly to the heating layer 10 of the vapor tank 1.

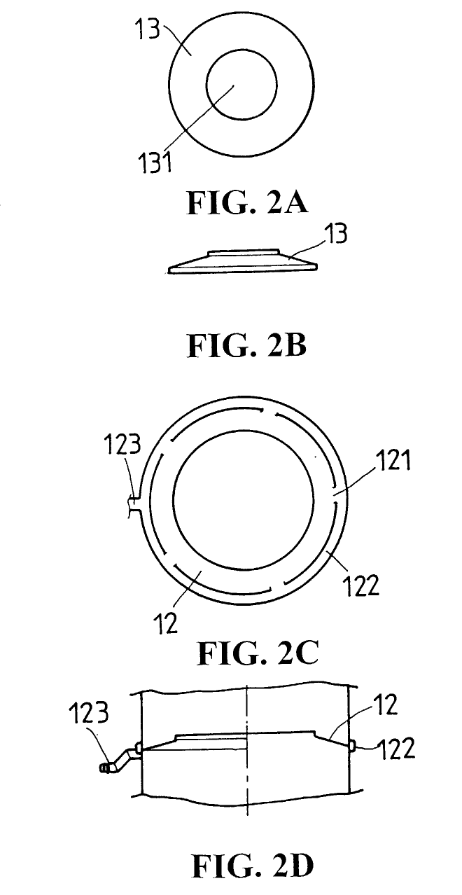

Referring to FIGS. 2A, 2B, 2C and 2D, the top end of the vapor tank 1 is provided with a baffling tank 12 having a hollow axis and the tank 12 is covered with a baffling plate 13. The baffling tank 12 is tapered and the edge thereof is provided with a plurality of overflow ports 121. The furthest external edge of the tank 12 is formed into an external tank 122 and is extended to provide a baffling tube 123 which can be connected to the external of the vapor tank 1. The baffling plate 13 covers correspondingly to the hollow axis of the baffling tank 12. The edge of the tank 12 is tapered shape and the central axis is formed into an outlet 131. Next, the vapor 1 is extended upward to form a tank cover 15 at an appropriate space. The inner side edge of the tank cover 15 is provided with a cooling plate 151. The cooling plate 151 provides lowered temperature equilibrium via the cooling inlet C1 and cooling outlet C2, forming cooling tube. A condensation region 14 is formed between the tank cover 15 and the baffling plate 13, and the bottom end of the vapor tank 1 is provided with a residues discharging port 16. Thus, after distillation, the residue is discharged from the vapor tank 1.

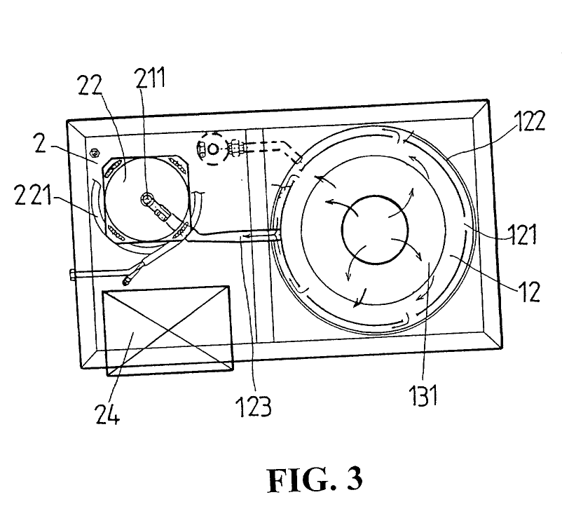

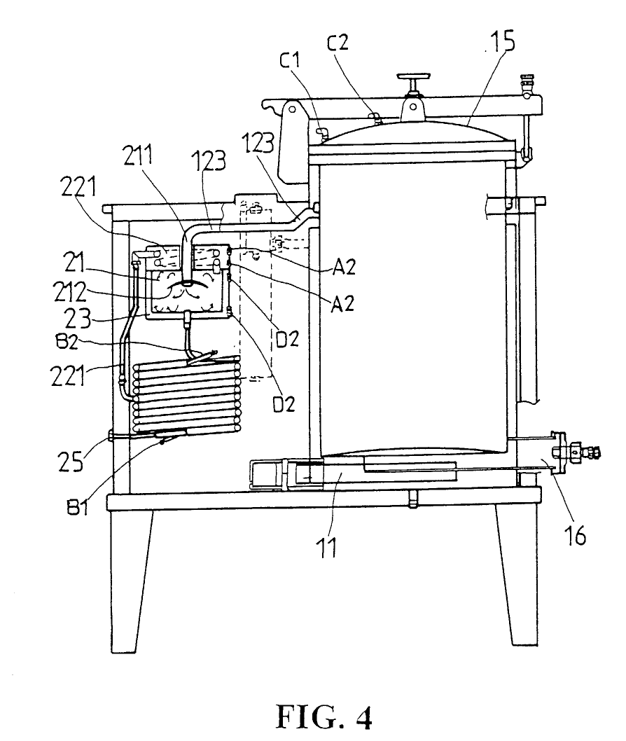

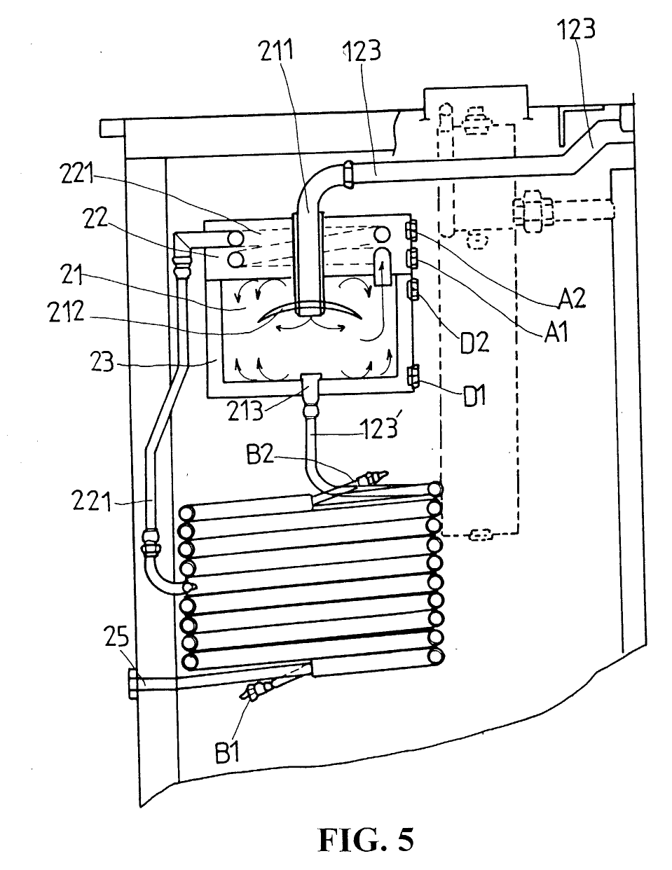

Referring to FIGS. 3 and 4, the baffling tube 123 is extended outward to the cooling and buffering region 2. The baffling tube 123 connects to the cooling and buffering region 2. The cooling and buffering region 2 is provided with a buffering region 21, which is a tank body having a hollow cavity, and the top end of the riddle of the body is provided with a hollow sleeve 211 with heat isolation, which is connected to the baffling tube 123. The hollow sleeve 211 within the buffering region 21 is extended to a hollow baffling plate 212 having an arch shape facing downward. The bottom end of the buffering region 21 is provided with an outlet 213 connected to the baffling tube 123′. The outer layer of the baffling tube 123′ is covered with cooling tube which is constituted from the cooling inlet B1 at the bottom end and the cooling outlet B2 at the top end. The cooling tube of the baffling tube 123′ corresponding to the top end of the buffering region 21 is provided with the cooling inlet A1 and the cooling outlet A2, and the condensation region 22 is provided with coiled hollow tube 221. One end of the hollow tube 251 is connected to the buffering region 21, and the other end is connected to the baffling tube 123′ at the lower section. Further, the outer side of the buffering region 21 is provided with a constant temperature region 23. The region 23 corresponds to the cooling tube having a cooling inlet D1 and a cooling outlet D2. The external of the cooling and buffering region 2 is provided with an electrical control section 24 which can control power source and temperature of the individual components of the entire device. A plurality of automatic control elements can be used.

When solution to be distilled and recycled is placed into the tank 1, the heating tube 11 is in operation and indirect heat is provided by the heating layer 10 such that vapor moves upward, via outlet 131 of the baffling plate 13 and into the condensation region 14 of the baffling tank 12. Due to the fact that the baffling tank 12 and the baffling plate 13 are tapered downward, the recycled product at the condensation region 14 is cooled by means of cooling plate 151 to form first condensate and the mixed liquid/gas is then collected at the outer tank 122 and is then passed through the baffling tube 123 to the cooling buffering region 2 to the buffering region 21. When the recycled product containing liquid and heated air flows to the buffering region 21, the liquid state of the recycled product will flow to the outlet at the bottom end of the buffering region 21, connecting to the baffling tube 123′. The temperature of the cooling tube is then cooled and is discharged via the recycling port 25. The heated air is isolated by the hollow blocking plate 212 of the buffering region, and is moved upward to the hollow tube 221, which is then cooled to form condensate. The heated air which has not been condensated will flow to the hollow tube 221 and to the externally connected baffling tube 123′ for final recycling process.

Due to the fact that the types of solutions for distillation are different, the time and temperature for distillation process are different. When the pressure of the recycled solution is insufficient, the rate of recycle is slow and the recycled liquid is not obtained. At this instance, the control section 24 senses the change of temperature and is processed to second stage heating so that the vapor tank 1 proceeds to second stage distillation. When the recycled product has stopped, the control section 24 senses the temperature change and at this stage, power supply and water supply are stopped. The condensation region 22, the baffling tube 123′, the cooling plate 151 and the constant temperature region 23 are provided respectively with the cooling inlet A1, B1, C1, D1 and the cooling outlet A2, B2, C2, D2. By employing water cooling method, the cooling water is first placed into A1→A2→B1→B2→C1→C2→D1→D2. In accordance with the present invention, the temperature equilibriums of the individual components are taken into account such that the recycled product after distillation can smoothly flow into individual components and then to the baffling tube 123′ and is then flown to the recycled port 25.

In accordance with the present invention, the advantages are as follows:

(1) The condensation region. The top section of the vapor tank is formed into a condensation region and the cooling plate provides first step condensation which effectively avoid excessive vapor flows into the vapor tank. Therefore, it effectively enhances rate of recycling process.

(2) The balanced temperature in the baffling tube is lowered and this allows recycled solution to flow smoothly.

(3) The recycled solution has a stable temperature and therefore the temperature will not contaminate the environment.

(4) The distillation and recycling device is applicable to food distillation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A distillation and recycling treatment device having a vapor tank, characterized in that the bottom end of the vapor tank is provided with a heater, and the top end of the vapor tank is provided with a baffling tank covered with a baffle, the external end of the baffling tank is extended to a baffling tube connected to a cooling buffer region having a condensation region and a buffering region, the condensation region connects the cooling inlet or outlet for feedback cooling and the upper end of the buffering region via the condensation region is provided with a hollow sleeve connected to the baffling tube, and the lower end of the buffering region is provided with an outlet connected to the baffling tube, whereby liquid for distillation is heated to vapor which flows into the condensation region as condensate via the baffle and the baffling tank and via the baffling tube, to the cooling buffering region so as to complete distillation and recycling, by means of the partitioning of the baffling tank to form the condensation region the recycled liquid will not re-flow but smoothly flow to the baffling tube.

2. The distillation and recycling treatment device of claim 1, wherein the inner side of the tank cover is provided with cooling plates.

3. The distillation and recycling treatment device of claim 1, wherein the upper end of the buffering region is provided with a hollow tube connected to the lower end of the baffling tube.

4. The distillation and recycling treatment device of claim 1, wherein the outer layer of the buffering region is provided with a constant temperature region connecting the cooling outlet and inlet to the cooling tube.

5. The distillation and recycling treatment device of claim 1, wherein the buffering region at the bottom end of the hollow sleeve is provided with hollow baffles.
